(19) United States
(12) Patent Application Publication
(10) Pub. No.: US 2007/0263576 A1
(43) Pub. Date: Nov. 15, 2007

(54) MULTICARRIER RADIO COMMUNICATION SYSTEM, CONTROL STATION, BASE STATION AND METHOD

(75) Inventor: Noritaka Deguchi, Kawasaki-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/617,185

(22) Filed: Dec. 28, 2006

(30) Foreign Application Priority Data
Jan. 16, 2006 (JP) 2006- 7651

(51) Int. Cl. H04Q 7/24

(52) U.S. Cl. 370/338; 370/328

(57) ABSTRACT

There is provided with a control station which controls a plurality of base stations whose respective communication areas partially overlap one another and each of which uses same frequency band dividing into one or more divided bands, including: a division pattern receiver configured to receive information indicating a division pattern of the frequency band from each the base station; a dedicated subcarrier setting section configured to set for each the base station some of subcarriers included in at least one divided band in the frequency band as dedicated subcarriers which are available only for the base station and which are not available for the other base stations; and a dedicated subcarrier informer configured to inform each the base station of dedicated subcarrier information indicating dedicated subcarriers set for the base stations.

### CROSS-REFERENCE TO RELATED APPLICATIONS

This application is based upon and claims the benefit of priority from the prior Japanese Patent Applications No. 2006-7651 filed on Jan. 16, 2006, the entire contents of which are incorporated herein by reference.

### BACKGROUND OF THE INVENTION

1. Field of the Invention

The present invention relates to a multicarrier radio communication system, control station, base station and multicarrier radio communication method, and more particularly, to a technology for using the same frequency band among a plurality of base stations.

2. Related Art

In a radio communication system made up of base stations and radio communication terminals which exist within communication areas of the base stations, such base stations need to be arranged so that communication areas of neighboring base stations overlap one another in order to secure a stable communication range for all radio communication terminals. In this case, a mobile communication terminal which is located in an overlapping area receives radio signals from other base stations different from the base station to which the mobile communication terminal belongs, in addition to radio signals incoming from the base station, and therefore radio signals from other base stations produce interference with radio signals from the base station. Furthermore, radio signals transmitted from the radio communication terminal also reaches other base stations different from the base station, and therefore this causes interference with other radio communication terminals which belong to other base stations. One method to solve such a problem is that neighboring base stations use different frequency bands. In this case, since the frequency bands are different from one another, interference as described above never occurs. Hereinafter, the above described interference will be referred to as “inter-cell interference.”

However, with limited frequency resources taken into consideration, the neighboring base stations preferably use the same frequency band. For this reason, in some of conventional radio communication systems, all base stations use the same frequency band. For example, by using a code division multiple access scheme as the radio access scheme, assigning different pseudo-random codes to all base stations and multiplying signals transmitted from the respective base stations by the codes, these systems randomize interference and reduce influences of interference through spreading gains.

On the other hand, an orthogonal frequency division multiplex scheme is becoming a focus of attention as a radio access scheme in recent years. This scheme carries out a radio communication using a plurality of orthogonal frequency carriers. The above described problem of interference also exists in this case, but, for example, JP-A 2004-207983 (KOKAI) discloses a technique for solving this problem. This technique defines some of frequency carriers as control subcarriers for transmitting control data and assigns different control subcarriers to the neighboring base stations. Thus, even when communication areas of the neighboring base stations overlap one another, since the neighboring base stations are transmitting control data by different subcarriers, the above described interference never occurs in the control data. Furthermore, with regard to traffic data, a combination with the above described code division multiple access scheme makes it possible to reduce the above described interference.

On the other hand, there is a method whereby some of all frequency carriers are defined as inter-base-station coordinated subcarriers, the inter-base-station coordinated subcarriers are divided and different inter-base-station coordinated subcarriers are assigned to neighboring base stations respectively. In this way, even when communication areas of the neighboring base stations overlap one another, since the base stations have different subcarriers, the above described interference never occurs with respect to the inter-base-station subcarriers.

Radio communication systems in recent years provide a variety of services from services requiring high transmission speed such as delivery of images to services which operate sufficiently at a low transmission speed but require a low delay time such as speech communication. Against a background of such a situation, recent radio communication systems tend to operate using a plurality of frequency bandwidths. For example, a certain base station operates with a bandwidth of X (MHz) which is a bandwidth of the entire frequency band, while other base stations neighboring this base station operate with two bandwidths of X/2 (MHz) and further other base stations neighboring this base station operate with four bandwidths of X/4 (MHz).

The conventional technique using the above described inter-base-station coordinated subcarriers is effective, because when bandwidth operating patterns in neighboring base stations are the same, inter-base-station coordinated subcarriers can be set at specified positions. However, when bandwidth operating patterns in the neighboring base stations are different, the operating pattern varies from one base station to another, and therefore more efforts are required for settings of inter-base-station coordinated subcarriers as the number of base stations increases. Furthermore, when an operating pattern of a base station can be changed, it is difficult to predict all combinations of operating patterns among neighboring base stations beforehand.

### SUMMARY OF THE INVENTION

According to an aspect of the present invention, there is provided with a multicarrier radio communication system including a plurality of base stations whose respective communication areas partially overlap one another and each of which uses same frequency band dividing into one or more divided bands, and a control station which controls the plurality of base stations,

the control station comprising:

a division pattern receiver configured to receive information indicating a division pattern of the frequency band from each the base station;

a dedicated subcarrier setting section configured to set for each the base station some of subcarriers included in at least one divided band in the frequency band as dedicated subcarriers which are available only for the base station and which are not available for the other base stations; and

a dedicated subcarrier informer configured to inform each the base station of dedicated subcarrier information indicating dedicated subcarriers set for the base stations, and

the base station comprising:

a division pattern informer configured to inform the control station of the information indicating the division pattern;

a dedicated subcarrier information receiver configured to receive the dedicated subcarrier information from the control station;

a dedicated subcarrier information deliverer configured to deliver the dedicated subcarrier information to radio communication terminals inside a communication area;

a judgment section configured to judge whether a radio communication terminal as a communication target is located in an interference area overlapping with a communication area of one or more other base station or in a non-interference area other than the interference area; and

a communication section configured to communicate with the radio communication terminal using the dedicated subcarriers when the radio communication terminal is located in the interference area and using subcarriers other than the dedicated subcarriers and not corresponding to the dedicated subcarriers of the other base stations when the radio communication terminal is located in the non-interference area.

According to an aspect of the present invention, there is provided with a control station which controls a plurality of base stations whose respective communication areas partially overlap one another and each of which uses same frequency band dividing into one or more divided bands, comprising:

a division pattern receiver configured to receive information indicating a division pattern of the frequency band from each the base station;

a dedicated subcarrier setting section configured to set for each the base station some of subcarriers included in at least one divided band in the frequency band as dedicated subcarriers which are available only for the base station and which are not available for the other base stations; and

a dedicated subcarrier informer configured to inform each the base station of dedicated subcarrier information indicating dedicated subcarriers set for the base stations.

According to an aspect of the present invention, there is provided with a base station whose communication area partially overlaps communication areas of other base stations and which uses same frequency band as those of the other base stations dividing into one or more divided band, comprising:

a division pattern informer configured to inform division pattern information indicating division pattern of the frequency band to a control station which controls base stations;

a dedicated subcarrier information receiver configured to receive dedicated subcarrier information indicating dedicated subcarriers set for at least one divided band in the frequency band which are exclusively available and which are not available for the other base stations, together with information indicating dedicated subcarriers of the other base stations from the control station;

an information delivery section configured to deliver the received dedicated subcarrier information to radio communication terminals inside a communication area;

a judgment section configured to judge whether a radio communication terminal as a communication target is located in an interference area overlapping with a communication area of one or more other base station or in a non-interference area other than the interference area; and

a communication section configured to communicate with the radio communication using the dedicated subcarriers when the radio communication terminal is located in the interference area and using subcarriers other than the dedicated subcarriers and not corresponding to the dedicated subcarriers of the other base stations when the radio communication terminal is located in the non-interference area.

According to an aspect of the present invention, there is provided with a multicarrier radio communication method using a plurality of base stations whose respective communication areas partially overlap one another and each of which uses same frequency band dividing into one or more divided bands, and a control station which controls the plurality of base stations, comprising:

informing division pattern information indicating division pattern of the frequency band from each the base station to the control station;

setting for each the base station some of subcarriers included in at least one divided band in the frequency band as dedicated subcarriers which are available only for the base station and which are not available for other base stations;

delivering dedicated subcarrier information indicating dedicated subcarriers set for the base stations to each the base station and radio communication terminals inside communication areas of the base stations;

judging whether a radio communication terminal as a communication target of the base station is located in an interference area overlapping with a communication area of one or more other base station or in a non-interference area other than the interference area;

carrying out a communication between the base station and the radio communication terminal using dedicated subcarriers set for the base station when the radio communication terminal is located in the interference area; and

carrying out a communication between the base station and the radio communication terminal using subcarriers other than the dedicated subcarriers and not corresponding to the dedicated subcarriers of the other base stations when the radio communication terminal is located in the non-interference area.

### BRIEF DESCRIPTION OF THE DRAWINGS

FIG. 1 illustrates base station communication areas and areas where inter-cell interference occurs;

FIG. 2 illustrates base station communication areas and areas where inter-cell interference occurs;

FIG. 3 shows a configuration example of a multicarrier radio communication system as an embodiment of the present invention;

FIG. 4 illustrates a radio communication scheme used in the radio communication system in FIG. 3;

FIG. 5 illustrates frequency bandwidths used in the radio communication system in FIG. 3;

FIG. 6 illustrates a basic mode of use of frequencies in the radio communication system in FIG. 3;

FIG. 7 illustrates specifically examples of the number of subcarriers available in respective frequency bandwidths shown in FIG. 5;

FIG. 8 illustrates a first setting example of inter-base-station coordinated subcarriers;

FIG. 9 illustrates a second setting example of inter-base-station coordinated subcarriers;

FIG. 10 illustrates a third setting example of inter-base-station coordinated subcarriers;

FIG. 11 illustrates a fourth setting example of inter-base-station coordinated subcarriers;

FIG. 12 illustrates a fifth setting example of inter-base-station coordinated subcarriers;

FIG. 13 illustrates a sixth setting example of inter-base-station coordinated subcarriers;

FIG. 14 illustrates a seventh setting example of inter-base-station coordinated subcarriers;

FIG. 15 illustrates an eighth setting example of inter-base-station coordinated subcarriers;

FIG. 16 illustrates a ninth setting example of inter-base-station coordinated subcarriers;

FIG. 17 illustrates a tenth setting example of inter-base-station coordinated subcarriers;

FIG. 18 illustrates an eleventh setting example of inter-base-station coordinated subcarriers;

FIG. 19 is sequence diagram showing a sequence example of inter-base-station coordinated subcarrier control;

FIG. 20 is a block diagram showing a configuration example of a base station according to an embodiment of the present invention; and

FIG. 21 is a block diagram showing a configuration example of a radio communication terminal according to an embodiment of the present invention.

### DETAILED DESCRIPTION OF THE INVENTION

Hereafter, an embodiment of the present invention will be described more specifically with reference to the drawings.

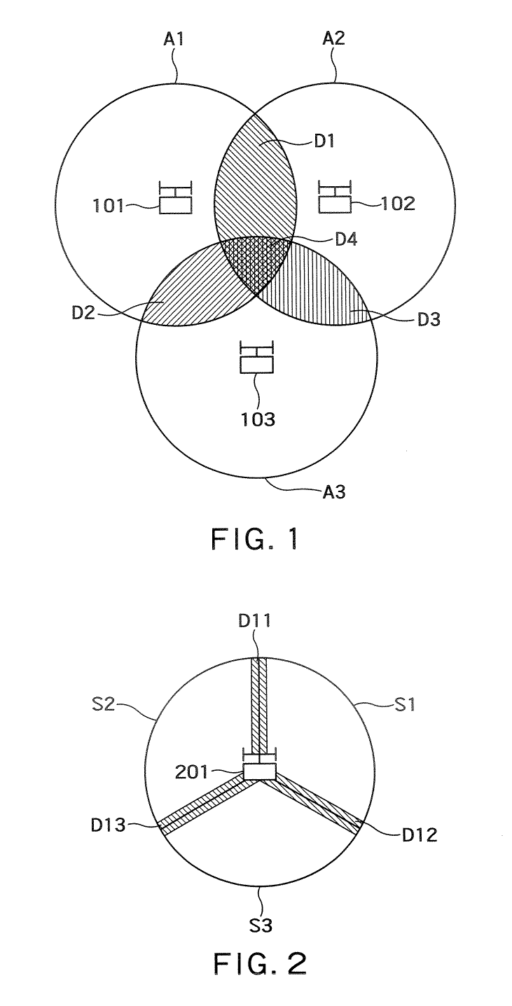

FIG. 1 and FIG. 2 illustrate base station communication areas and areas where inter-cell interference occurs.

FIG. 1 shows an example where three base stations exist. Base stations 101, 102 and 103 have communication areas A1, A2, A3 respectively. The respective communication areas A1, A2, A3 include interference areas where a plurality of communication areas overlap one another, that is, inter-cell interference occurs. More specifically, there are such interference areas as an interference area D1 where the communication area A1 of the base station 101 and the communication area A2 of the base station 102 overlap each other, an interference area D2 where the communication area A1 of the base station 101 and the communication area A3 of the base station 103 overlap each other, an interference area D3 where the communication area A2 of the base station 102 and the communication area A3 of the base station 103 overlap each other, and an interference area D4 where the communication area A1 of the base station 101, the communication area A2 of the base station 102 and the communication area A3 of the base station 103 overlap each other.

FIG. 2 shows an example where one base station 201 includes three communication areas S1, S2, S3. In this case, the communication areas S1, S2, S3 include interference areas, too. More specifically, there are an interference area D11 where the communication area S1 and communication area S2 overlap each other, an interference area D12 where the communication area S1 and communication area S3 overlap each other and an interference area D13 where the communication area 52 and communication area S3 overlap each other.

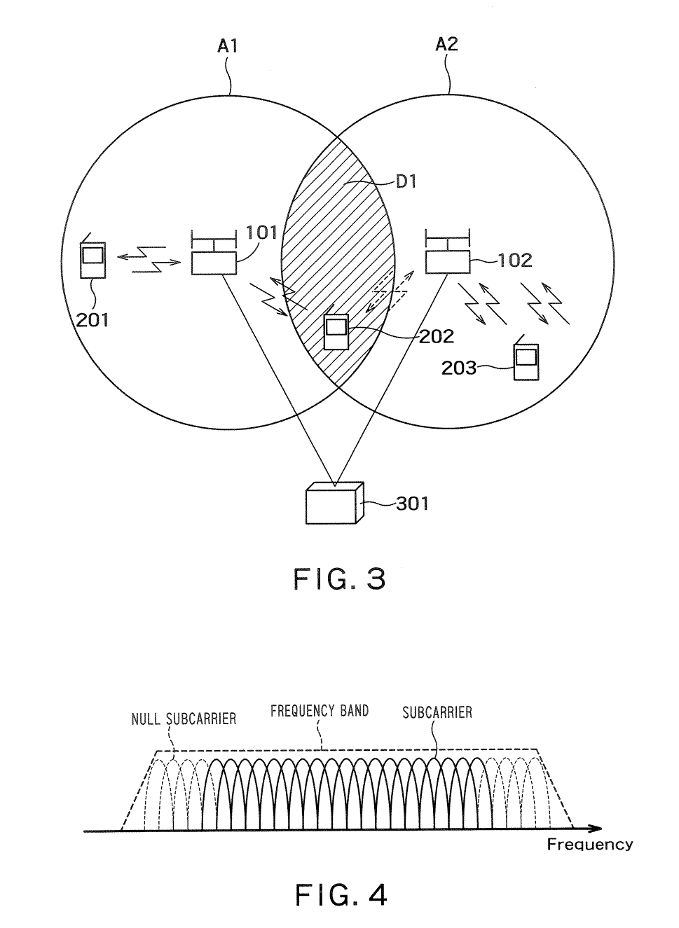

FIG. 3 shows a configuration example of a radio communication system according to an embodiment of the present invention.

For simplicity of explanation, suppose there are two base stations (101, 102), three radio communication terminals (201, 202, 203) and one control station (301). However, the present invention is not limited to this and it is also possible to construct a radio communication system with an arbitrary number of base stations, an arbitrary number of radio communication terminals and an arbitrary number of control stations. Furthermore, the example in FIG. 3 shows a case where one base station includes one communication area as in the case of FIG. 1, but the present invention is also applicable to a case where one base station includes a plurality of communication areas as shown in FIG. 2.

In FIG. 3, the base station 101 and the base station 102 have communication areas A1, A2 respectively. There is an interference area D1 where the communication areas A1, A2 partially overlap each other. The radio communication terminals 201, 202 and 203 exist within a communication area of at least one of the base stations 101, 102 (i.e. belong to any one of the base stations 101, 102), thereby perform a radio communication with the base station. In this example, the radio communication terminal 201 exists in the communication area A1 of the base station 101 and is carrying out a radio communication with the base station 101. The radio communication terminal 202 exists in the interference area D1 where the communication areas of the base station 101 and base station 102 overlap each other and the radio communication terminal 202 is carrying out a radio communication with the base station 101 here. The radio communication terminal 203 exists within the communication area A2 of the base station 102 and is carrying out a radio communication with the base station 102. The control station 301 controls a plurality of base stations in a centralized manner. Suppose a communication between the base station 101 and radio communication terminals within the communication area A1 and a communication between the base station 102 and radio communication terminals within the communication area A2 are carried out using the same frequency band.

Here, attention will be focused on the radio communication terminal 202. The radio communication terminal 202 is carrying out a radio communication with the base station 101, but since it is also located in the communication area A2 of the base station 102, it receives radio signals from the base station 102 for other radio communication terminals such as the radio communication terminal 203 which exists inside the communication area A2. Therefore, the radio communication terminal 202 is affected by interference of the radio signals from the base station 102 with respect to the radio communication with the base station 101. Furthermore, the radio signal of the radio communication terminal 202 for the base station 101 also arrives at the base station 102. This means that the radio signal of the radio communication terminal 202 causes interference with other radio communication terminals such as the radio communication terminal 203 communicating with the base station 102. However, in the interference area D1, the radio communication terminal 202 is enabled to perform a radio communication without causing interference using inter-base-station coordinated subcarriers which will be described later. The radio communication system in FIG. 3 will be explained in more detail below.

FIG. 4 illustrates a radio communication scheme used in the radio communication system in FIG. 3.

The “radio communication scheme” refers to a mode of radio communication between a base station and a radio communication terminal. The radio communication scheme used in the radio communication system in FIG. 3 is a multicarrier radio communication scheme as shown in FIG. 4 in which a radio communication is carried out using a plurality of frequency subcarriers. Here, an orthogonal frequency division multiplex scheme which is a mode of multicarrier radio communication scheme is shown. In this radio communication scheme, some subcarriers at both ends of an entire available frequency band are regarded as “null subcarriers” and not used and a radio communication is performed using a plurality of remaining orthogonal subcarriers.

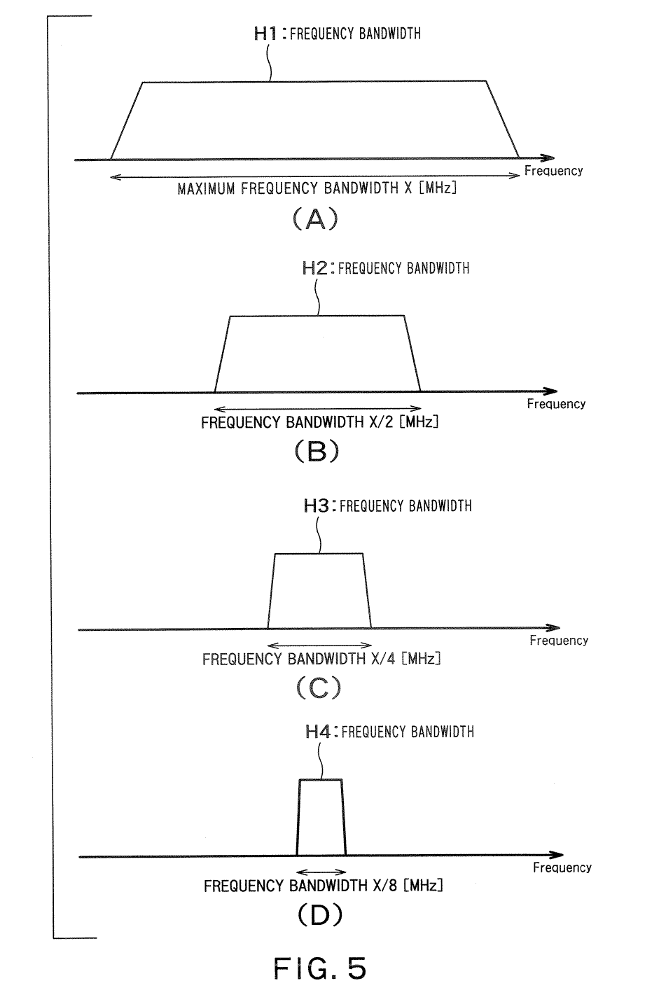

FIG. 5 illustrates frequency bandwidths used in the radio communication system in FIG. 3.

Four frequency bandwidths H1 to H4 are shown. However, the present invention is also applicable to frequency bandwidths other than these bandwidths. The frequency bandwidth H1 is a bandwidth of an entire frequency band available to this radio communication system and is assumed to be X [MHz] here. The frequency bandwidth H2 is a frequency bandwidth smaller than the frequency bandwidth H1 and is assumed to be X/2 [MHz] here. The frequency bandwidth H3 is a frequency bandwidth smaller than the frequency bandwidth H2 and is assumed to be X/4 [MHz] here. The frequency bandwidth H4 is a frequency bandwidth smaller than the frequency bandwidth H3 and is assumed to be X/8 [MHz] here. If the maximum frequency bandwidth X is assumed to be 20 MHz, the frequency bandwidth H1 is 20 MHz, frequency bandwidth H2 is 10 MHz, frequency bandwidth H3 is 5 MHz and frequency bandwidth H4 is 2.5 MHz.

The base station is operated with an arbitrary number of frequency bandwidths within the range of the maximum frequency bandwidth X. For example, the base station may be operated with one frequency bandwidth H1, may also be operated with two frequency bandwidths H2, may also be operated with one frequency bandwidth H2 and two frequency bandwidths H3, may also be operated with four frequency bandwidths H4, may also be operated with one frequency bandwidth H4 or may also be operated with one frequency bandwidth H2. Such an operating pattern of the frequency band is called a “frequency band operating pattern” or “division pattern.” The radio communication terminal carries out a radio communication with the base station using one or two or more frequency bandwidths out of one or a plurality of frequency bandwidths in a frequency band operating pattern of the base station. One frequency bandwidth used for a radio communication may be called a “radio channel.”

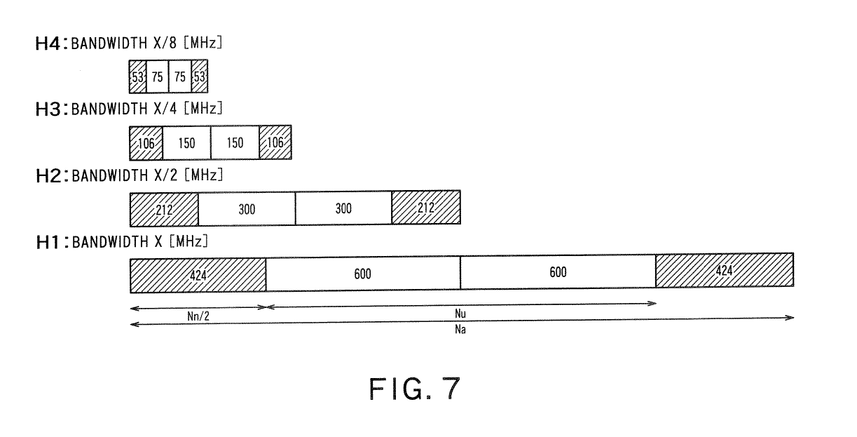

FIG. 7 shows examples of the numbers of subcarriers available with the respective frequency bandwidths H1 to H4.

For the respective frequency bandwidths H1 to H4, suppose the total number of subcarriers is Na, the number of available subcarriers is Nu and the number of null subcarriers is Nn. Na=2048, Nu=1200, Nn=848 in the case of the maximum frequency bandwidth X[MHz], Na=1024, Nu=600, Nn=424 in the case of the frequency bandwidth X/2[MHz], Na=512, Nu=300, Nn=212 in the case of the frequency bandwidth X/4[MHz] and Na=256, Nu=150, Nn=106 in the case of the frequency bandwidth X/8[MHz].

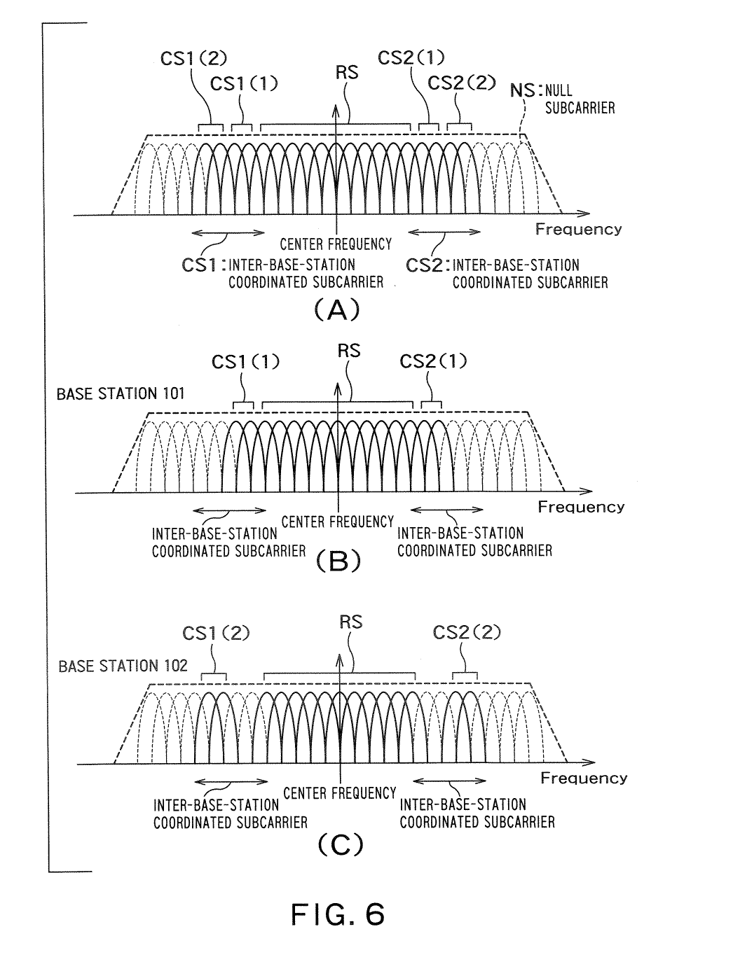

FIG. 6(A) to FIG. 6(C) illustrate basic modes of a method of use of frequencies in the radio communication system in FIG. 3.

Suppose two base stations 101, 102 are operated with one frequency bandwidth H1. Some of all subcarriers with the frequency bandwidth H1 are defined as inter-base-station coordinated subcarriers, these inter-base-station coordinated subcarriers are divided between neighboring base stations and different inter-base-station subcarriers (dedicated subcarrier) are assigned to the respective base stations. Interference between the neighboring cells is avoided by using dedicated subcarriers which differ from one base station to another in interference areas where the communication areas of the respective base stations overlap one another.

More specifically, as shown in FIG. 6(A), remaining subcarriers after removing null subcarriers NS from all the subcarriers included the frequency bandwidth H1 are assumed to be available subcarriers and four subcarriers at each of both ends in the available subcarriers are assumed to be inter-base-station coordinated subcarriers CS1, CS2 respectively. Furthermore, the inter-base-station coordinated subcarriers CS1 are divided into dedicated subcarriers CS1(1), CS1(2) and the inter-base-station coordinated subcarriers CS2 are divided into dedicated subcarriers CS2(1), CS2(2). The dedicated subcarriers CS1(1), CS2(1) are assigned to the base station 101 and the dedicated subcarriers CS1(2), CS2(2) are assigned to the base station 102. The dedicated subcarriers CS1(1), CS2(1) can be used (be available) only by the base station 101 and are prohibited from using for the base station 102 (are not available for the base station 102). The dedicated subcarrier CS1(2), CS2(2) can be used only by the base station 102 and are prohibited from use for the base station 101. Available subcarriers RS other than the inter-base-station coordinated subcarriers CS1, CS2 can be used by both the base stations 101, 102.

That is, when focused on the base station 101, as shown in FIG. 6(B), the subcarriers usable for the base station 101 are the subcarriers RS which can be used by both the base stations 101, 102 and the dedicated subcarrier CS1(1), CS2(1) assigned to the base station 101. As shown in FIG. 6(C), the subcarriers usable for the base station 102 are the subcarriers RS which can be used by both the base stations 101, 102 and the dedicated subcarriers CS1(2), CS2(2) assigned to the base station 102. In the interference area D1 where the communication areas of both the base stations 101, 102 overlap with each other, only the dedicated subcarriers CS1(1), CS2(1) are used for a communication between the radio communication terminal and the base station 101, while only the dedicated subcarriers CS1(2), CS2(2) are used for a communication between the radio communication terminal and the base station 102. In this way, inter-cell interference can be avoided in the interference area D1.

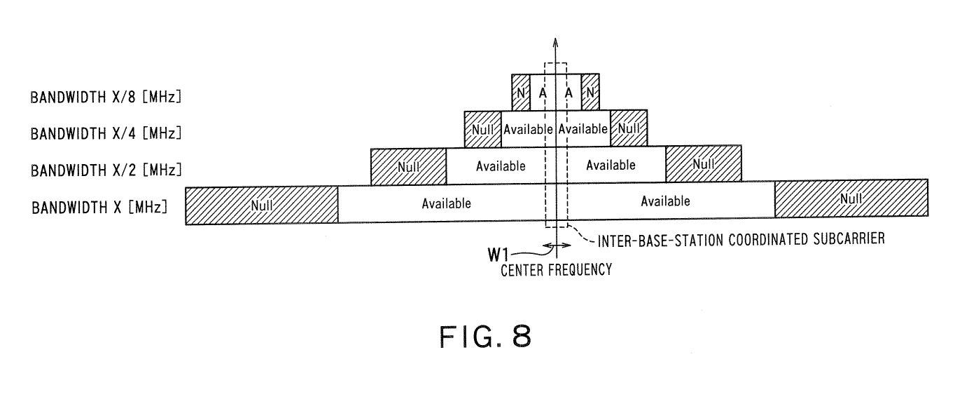

An setting example of the inter-base-station coordinated subcarriers will be explained using FIG. 8 to FIG. 18.

FIG. 8 shows a first setting example of inter-base-station coordinated subcarriers.

Suppose the neighboring base stations are operated with any one of the four frequency band operating patterns shown in FIG. 8. The first frequency band operating pattern at the top includes only one bandwidth X/8 having the same center frequency as the center frequency of the maximum frequency bandwidth X, the second frequency band operating pattern from the top includes only one bandwidth X/4 having the same center frequency as the center frequency of the maximum frequency bandwidth X, the third frequency band operating pattern from the top includes only one bandwidth X/2 having the same center frequency as the center frequency of the maximum frequency bandwidth X and the last frequency band operating pattern at the bottom includes the maximum frequency bandwidth X. The band actually occupied by each bandwidth may also be referred to as a “divided band.” In this embodiment, the inter-base-station coordinated subcarriers are set in a range shown by dotted line. The number W1 of inter-base-station coordinated subcarriers included in the range is less than or equal to Nu of the minimum frequency bandwidth X/8. This is because when the proportion of inter-base-station coordinated subcarriers in the total of the minimum frequency bandwidth X/8 is large, communications using the frequency bandwidth X/8 in areas other than the interference area are affected (drop of communication speed or the like). Inter-base-station coordinated subcarriers are divided according to the number of neighboring base stations and dedicated subcarriers are assigned to their respective base stations. The setting of the inter-base-station coordinated subcarriers illustrated is effective when the center frequency of each frequency bandwidth (radio channel) in all frequency band operating patterns matches the center frequency of the maximum frequency bandwidth as in this embodiment. In this case, it is possible to easily determine the setting of inter-base-station coordinated subcarriers.

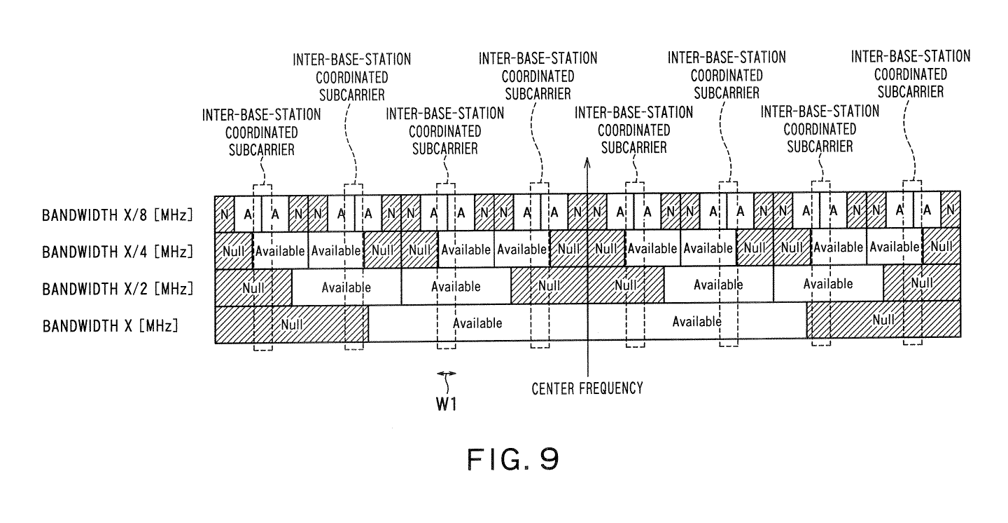

FIG. 9 shows a second setting example of inter-base-station coordinated subcarriers.

The first frequency band operating pattern at the top includes eight bandwidths X/8, the second frequency band operating pattern from the top includes four bandwidths X/4, the third frequency band operating pattern from the top includes two bandwidths X/2 and the last frequency band operating pattern at the bottom includes the maximum frequency bandwidth X. Inter-base-station coordinated subcarriers are set in each range shown by dotted lines. The number W1 of the inter-base-station coordinated subcarriers included in each range is less than or equal to Nu of the minimum frequency bandwidth (X/8[MHz]). Each range of inter-base-station coordinated subcarriers is centered on the center frequency of each frequency bandwidth (radio channel) in the first frequency band operating pattern at the top. As a result, inter-base-station coordinated subcarriers are always set in each frequency bandwidth (radio channel) in each frequency band operating pattern. In this way, since inter-base-station coordinated subcarriers are always set in each frequency bandwidth in each frequency band operating pattern, it is possible to avoid the occurrence of inter-cell interference in an interference area in an arbitrary frequency band operating pattern.

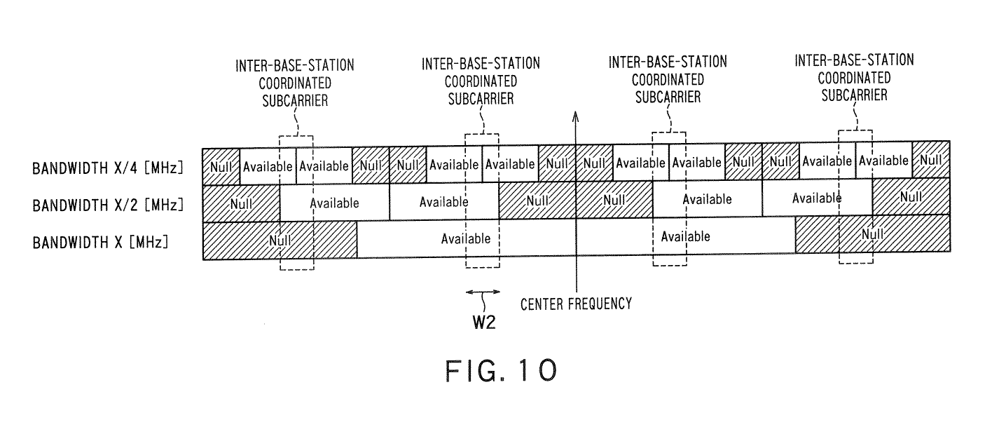

FIG. 10 shows a third setting example of inter-base-station coordinated subcarriers.

This example assumes a case where a minimum frequency bandwidth is defined as X/4[MHz] for all base stations. Three patterns are shown as frequency band operating patterns. The first frequency band operating pattern at the top includes four bandwidths X/4, the second frequency band operating pattern from the top includes two bandwidths X/2 and the last frequency band operating pattern at the bottom includes a maximum frequency bandwidth X. Inter-base-station coordinated subcarriers are set in each range shown by dotted lines. The number W2 of the inter-base-station coordinated subcarriers included in each range is less than or equal to Nu of a minimum frequency bandwidth (X/4[MHz]) in this case. Each range of inter-base-station coordinated subcarriers is centered on the center frequency of each bandwidth X/4 in the first frequency band operating pattern at the top. In this way, even when the minimum bandwidth is X/4, effects similar to those in FIG. 9 can be obtained.

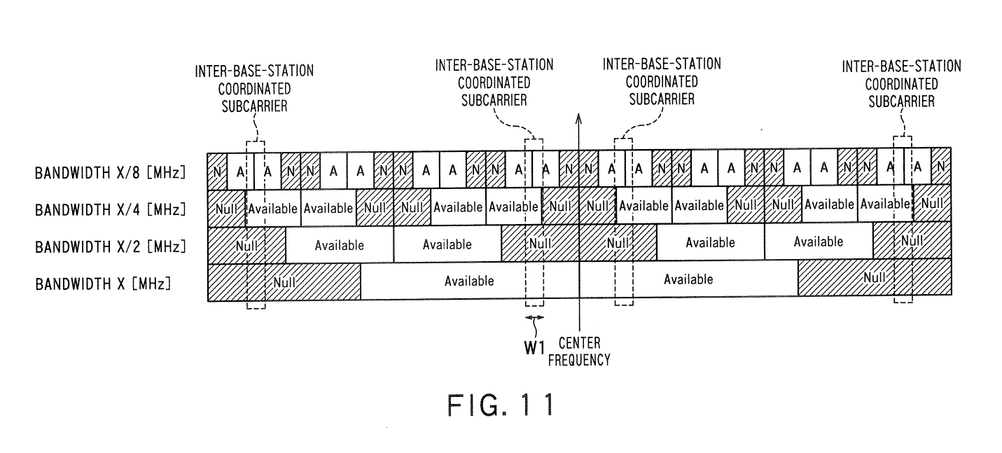

FIG. 11 shows a fourth setting example of inter-base-station coordinated subcarriers.

This example illustrates a case where the number of inter-base-station coordinated subcarriers to be set is reduced compared to FIG. 9. When the number of subcarriers for communications in a non-interference area (area other than interference area in a communication area) is insufficient even in the setting of inter-base-station coordinated subcarriers shown in FIG. 9, it is possible by adopting the setting shown in this example to secure more subcarriers for communications in non-interference areas.

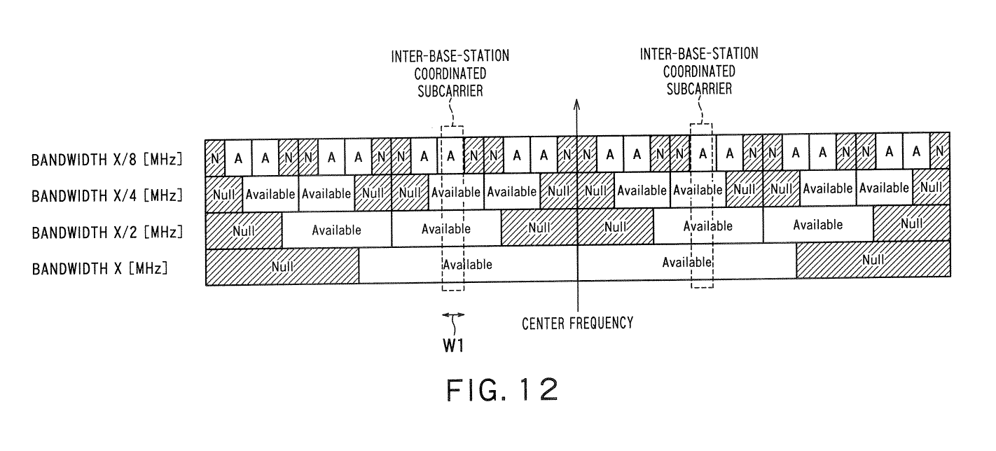

FIG. 12 shows a fifth setting example of inter-base-station coordinated subcarriers.

In this example, inter-base-station coordinated subcarriers are set in each range (shown by dotted lines) in which available subcarriers commonly exists in the respective frequency band operating patterns. The number W1 of the inter-base-station coordinated subcarriers included in each range is less than or equal to Nu of the minimum frequency bandwidth (X/8[MHz]). In this case, it is possible to easily determine the setting of inter-base-station coordinated subcarriers as in the case of FIG. 8.

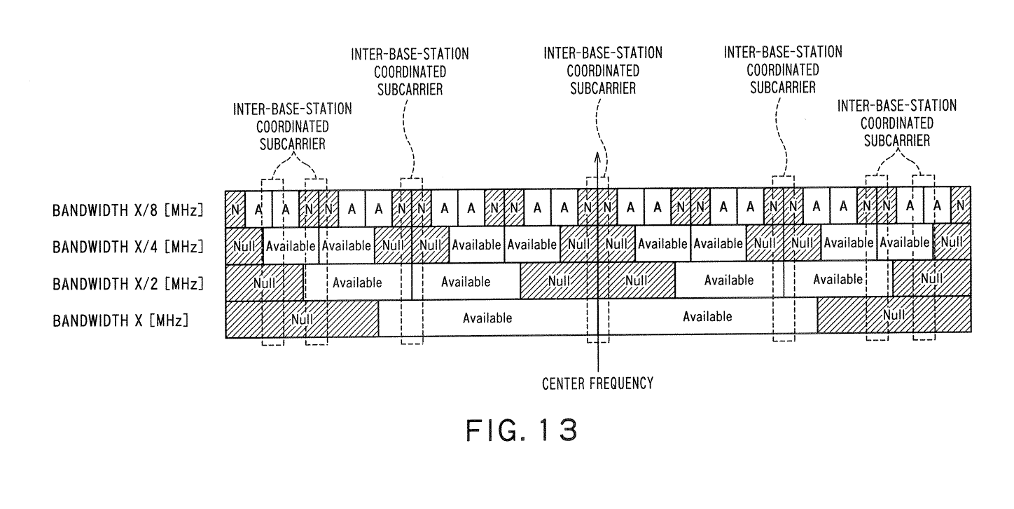

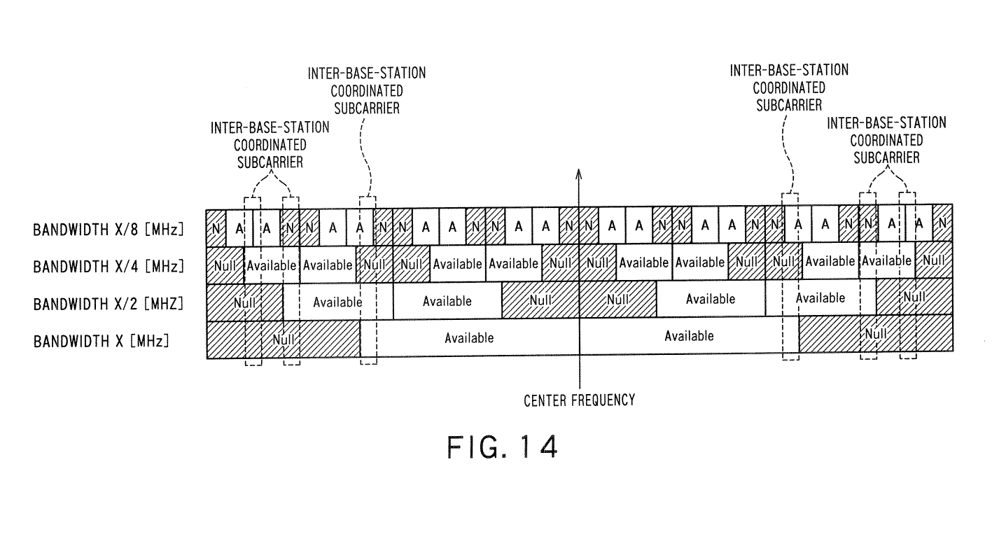

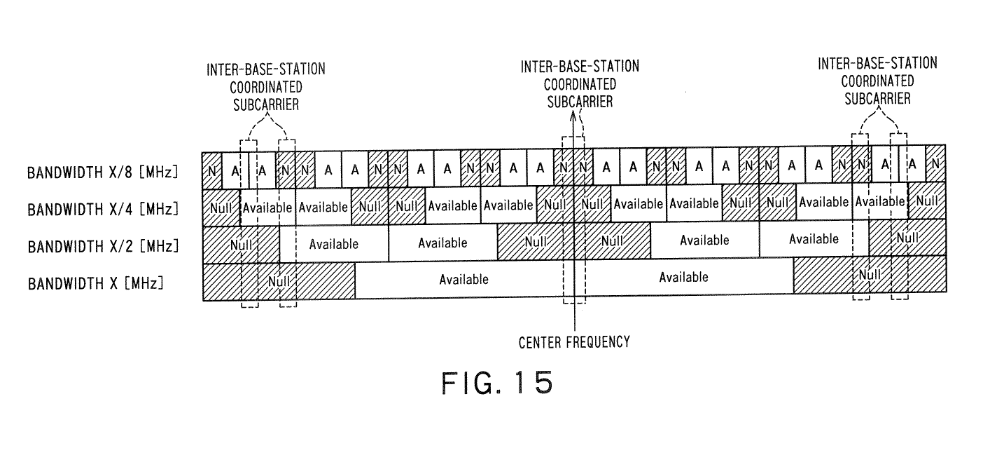

FIG. 13, FIG. 14 and FIG. 15 show sixth, seventh and eighth setting examples of inter-base-station coordinated subcarriers.

In these examples, inter-base-station coordinated subcarriers are set such that while they correspond to available subcarriers in at least one frequency band operating pattern, they correspond to null subcarriers in the remaining frequency band operating patterns. With such a setting, there is a high possibility that inter-base-station coordinated subcarriers in one base station of neighboring base stations may become null subcarriers in the remaining base stations. In this case, since all the inter-base-station coordinated subcarriers can be used by the same base station or can be divided and used among a few base stations, and therefore it is possible to realize effective utilization of subcarriers. In the former case, all the inter-base-station coordinated subcarriers are used as dedicated carriers by one base station.

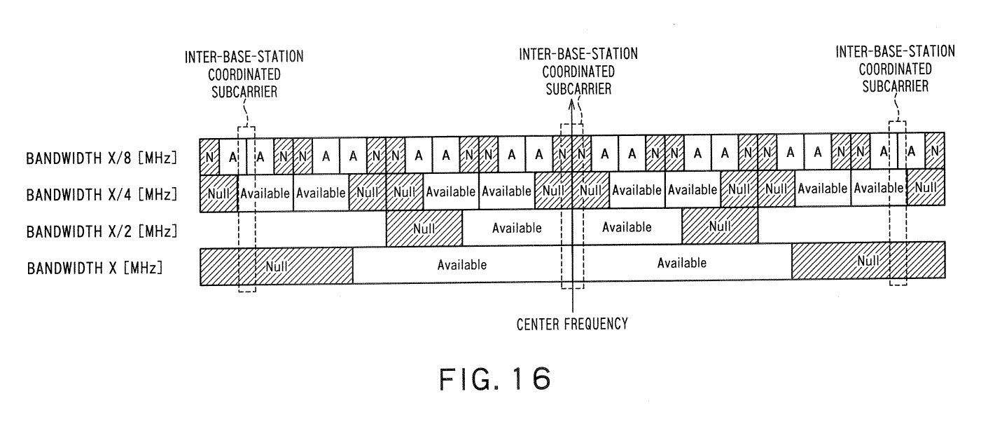

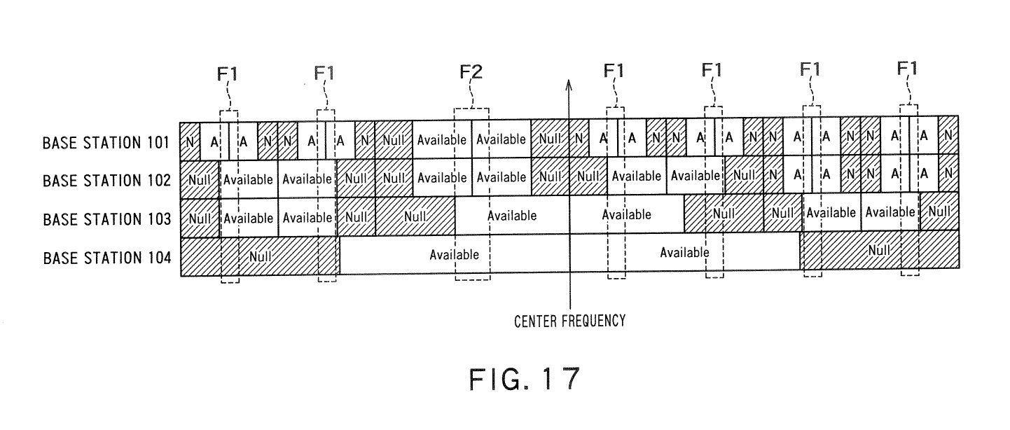

FIG. 16 shows a ninth setting example of inter-base-station coordinated subcarriers.

In this example, the third frequency band operating pattern from the top includes only one bandwidth X/2 and the remaining band (X/2) in an overall frequency band are not used. The other three frequency band operating patterns use an overall frequency band respectively. The bandwidth X/2 used in the third frequency band operating pattern from the top is arranged such that the center frequency thereof matches the center frequency of the maximum frequency bandwidth X. This example shows that even when frequency band operating patterns using an overall frequency band are mixed with a frequency band operating pattern using only a part of the overall frequency band, it is possible to prevent inter-cell interference by adequately setting inter-base-station coordinated subcarriers.

FIG. 17 shows a tenth setting example of inter-base-station coordinated subcarriers. This example assumes a case where four base stations of base stations 101, 102 in FIG. 3, and base stations 103, 104 (not shown) are arranged adjacent to each other.

In FIG. 17, the base station 101 is operated in a first frequency band operating pattern at the top, the base station 102 is operated in a second frequency band operating pattern from the top, the base station 103 is operated in a third frequency band operating pattern from the top and the base station 104 is operated in a fourth frequency band operating pattern from the top. Here, suppose a case where all frequency bandwidths (radio channels) included in the respective frequency band operating patterns require inter-base-station coordinated subcarriers. Thus, inter-base-station coordinated subcarriers are set with respect to all minimum frequency bandwidths first. The inter-base-station coordinated subcarriers set in this way are expressed as “F1.” Next, it is examined whether or not there are frequency bandwidths (radio channels) in which no inter-base-station coordinated subcarrier exists and if any such frequency bandwidth exists, the inter-base-station coordinated subcarrier is set on the frequency bandwidth. The inter-base-station coordinated subcarriers set in this way are expressed as “F2.” In this manner, it is possible to efficiently set inter-base-station coordinated subcarriers on all frequency bandwidths (radio channels) in all frequency band operating patterns.

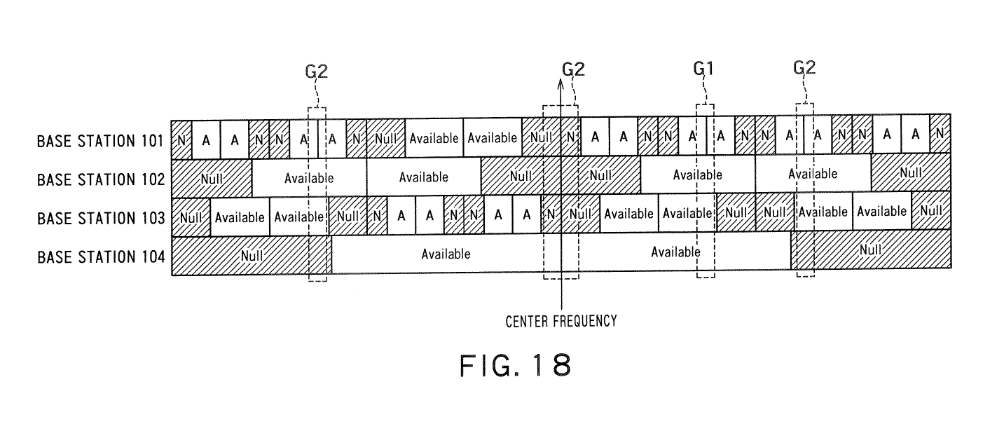

FIG. 18 shows an eleventh setting example of inter-base-station coordinated subcarriers. This example also assumes a case where four base stations; the base stations 101, 102 in FIG. 3 and base station 103, 104 (not shown) are adjacent to each other as in the case of FIG. 17.

Suppose inter-base-station coordinated subcarriers are required only for some frequency bandwidths (radio channels) in each of the frequency band operating patterns used by the base stations 101 to 104. For this reason, inter-base-station coordinated subcarriers are set in a range where available subcarriers exist commonly for all base stations as shown with “G1.” In this case, inter-base-station coordinated subcarriers can be set easily. Or inter-base-station coordinated subcarriers are set in a range in which subcarriers available commonly to some base stations exist and which corresponds to null subcarriers or unused subcarriers in remaining base station That is, as shown with “G2”, inter-base-station coordinated subcarriers are set at three locations. In this case, it is possible to improve effectiveness of subcarriers as in the cases of FIG. 13 to FIG. 15.

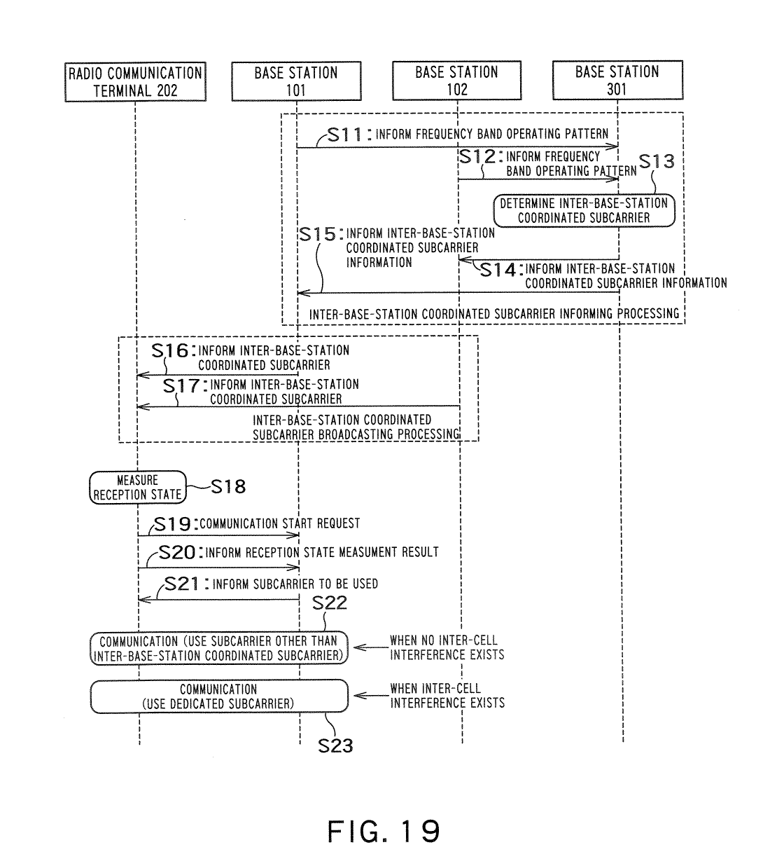

FIG. 19 shows an example of control sequence of subcarriers used for communications between base stations and radio communication terminal.

Base station 101 and base station 102 inform the control station 301 of the frequency band operating pattern (such as shown in FIGS. 8 to 18) used for a radio communication with radio communication terminals (S11, S12). The processing of S11 and S12, for example, correspond to the processing of a division pattern informer. Note that this notification may be performed based on a predetermined cycle or performed only when frequency band operating patterns are changed. The control station 301 receives the information on the frequency band operating pattern. This processing corresponds, for example, to the processing of a division pattern receiver. The control station 301 which has received the information on the frequency band operating pattern, determines inter-base-station coordinated subcarriers between the base stations 101, 102 and dedicated subcarriers for the base stations 101, 102 as in the examples shown in FIG. 8 to FIG. 18 (S13), and informs the decision result as inter-base-station coordinated subcarrier information to the base station 102 and base station 101 (S14, S15). This notification can be performed based on a predetermined cycle or performed only when inter-base-station coordinated subcarriers are changed. The processing of S13 corresponds, for example, to the processing of a dedicated subcarrier setting section. The processing of S14 and S15 correspond, for example, to the processing of a dedicated subcarrier informer.

The base station 101 and base station 102 receive the inter-base-station coordinated subcarrier information from the control station 301. This processing corresponds, for example, to the processing of a dedicated subcarrier receiver. The base station 101 and base station 102 send the received inter-base-station coordinated subcarrier information as broadcasting information to all radio communication terminals which exist within the area of the base station (S16, S17). For example, when the radio communication terminal 202 exists in the area of the base station 101, the broadcasting information is notified the radio communication terminal 202 of by the base station 101. On the other hand, when the radio communication terminal 202 exists in the area of the base station 102, the broadcasting information is notified the radio communication terminal 202 of by the base station 102. In this manner, by receiving the broadcasting information, the radio communication terminals 202 can grasp inter-base-station coordinated subcarriers between the base stations 101, 102 and dedicated subcarriers of the base stations 101, 102. The processing of S16 and S17 correspond, for example, to the processing of a dedicated subcarrier information deliverer.

Here, suppose the radio communication terminal 202 is trying to start a communication with the base station 101. The radio communication terminal 202 measures as reception state, for example, reception power using the dedicated subcarriers of the base station 102 acquired from the broadcasting information before starting a communication (S18). The processing of the S18 corresponds, for example, to the processing of a measuring section. After measuring the reception state, the radio communication terminal 202 informs the base station 101 of a communication start request and the reception state measurement result (S19, S20). The processing of the S20 corresponds, for example, to the processing of a measurement result informer.

The base station 101 which has received the communication start request determines subcarriers to be used for the communication using the informed reception state measurement result and informs the radio communication terminal 202 of the subcarriers (S21). The processing of the S21 corresponds, for example, to the processing of a judgment section. The subcarriers to be used for the communication are determined based on the presence/absence of inter-cell interference. Judgment on inter-cell interference can be made based on the reception state of the dedicated subcarriers of neighboring base stations other than the base station 101 (here, base station 102). For example, when the reception power of the dedicated subcarriers of the base station 102 is greater than a threshold, inter-cell interference exists and when it is equal to or lower than the threshold, interference between neighboring cells is judged not to exist. That is, since the dedicated subcarriers of the base station 102 are not used in the non-interference area of the base station 101, the reception power of the dedicated subcarriers of the base station 102 becomes greater only when the radio communication terminal 202 exists in the interference area of the base station 101 and base station 102. When inter-cell interference by the base station 101 is judged not to exist, that is, when the radio communication terminal exists in a non-interference area, communications using subcarriers other than the inter-base-station coordinated subcarriers are carried out (S22). In this case, when all the radio communication terminals which belong to the base station 101 exist in a non-interference area, the dedicated subcarriers of the base station 101 may be used for communications with the radio communication terminals. When interference between neighboring base stations is judged to exist, that is, when the radio communication terminal exists in the interference area, communications using the dedicated subcarriers of the base station 101 are carried out (S23).

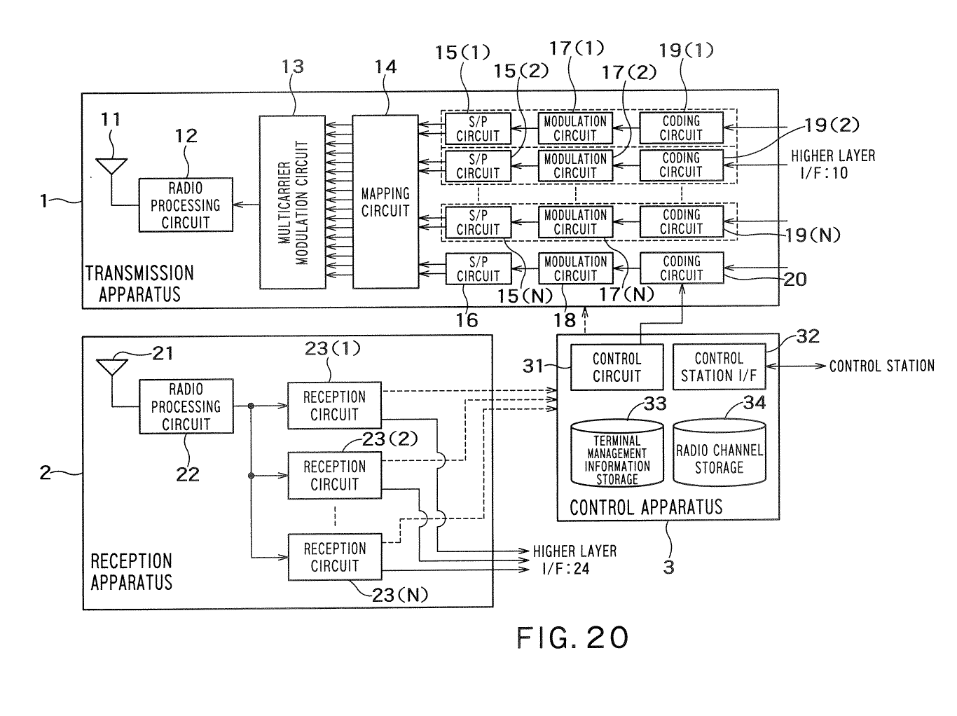

FIG. 20 is a block diagram showing a configuration example of the base station.

The base station is provided with a transmission apparatus 1, a reception apparatus 2 and a control apparatus 3.

The transmission apparatus 1 is provided with an antenna 11, a radio processing circuit 12, a multicarrier modulation circuit 13, a mapping circuit 14, S/P (serial/parallel) circuits 15(1) to 15(N), 16, modulation circuits 17(1) to 17(N), 18 and coding circuits 19(1) to 19(N), 20.

The reception apparatus 2 is provided with an antenna 21, a radio processing circuit 22 and reception circuits 23(1) to 23(N). The number of reception circuits 23(1) to 23(N) in the reception apparatus 2 and the number of S/P circuits 15(1) to 15(N), modulation circuits 17(1) to 17(N), coding circuits 19(1) to 19(N) in the transmission apparatus 1 correspond to the number of simultaneously communicable radio communication terminals.

The control apparatus 3 is provided with a control circuit 31, a control station I/F 32, a terminal management information storage 33 and a radio channel storage 34. The terminal management information storage 33 stores information such as identifications of radio communication terminals which carry out radio communications with the base station, radio channels used for communications with the radio communication terminals and the presence/absence of inter-cell interference of the radio communication terminals. The radio channel storage 34 stores radio channel information used by the base station (center frequency, frequency band operating pattern or the like) and information related to the inter-base-station coordinated subcarriers (information of inter-base-station coordinated subcarriers, and information of dedicated subcarriers used by the base station and other base stations).

Hereinafter, the transmission apparatus 1, reception apparatus 2 and control apparatus 3 will be explained in detail.

First, the transmission apparatus 1 will be explained.

The coding circuits 19(1) to 19(N) perform error correcting coding on transmission data inputted from a higher layer I/F 10 using a predetermined coding scheme and coding rate and input the result to modulation circuits 17(1) to 17(N). Furthermore, the coding circuit 20 performs error correcting coding on broadcasting information including the information related to inter-base-station coordinated subcarriers inputted from the control circuit 31 using a predetermined coding scheme and coding rate and inputs the result to modulation circuit 18.

The modulation circuits 17(1) to 17(N), 18 perform modulation on the inputted data according to a predetermined modulation scheme and inputs the modulated signals to the S/P circuits 15(1) to 15(N), 16 respectively.

The S/P circuits 15(1) to 15(N), 16 perform S/P conversion on the inputted modulated signals and input the converted signals to the mapping circuit (multiplexing circuit) 14.

The mapping circuit 14 maps the inputted modulated signals to their respective subcarriers. At this time, when there are radio communication terminals using dedicated subcarriers, the modulated signals of the relevant radio communication terminals are mapped to the dedicated subcarriers. Information on subcarriers to which the respective modulated signals are to be mapped and information on the radio communication terminals using the dedicated subcarriers or the like are informed from the control apparatus 3.

The multicarrier modulation circuit 13 performs multicarrier modulation on the respective modulated signals mapped by the mapping circuit 14 and inputs the resulting signal as multicarrier modulated signals to the radio processing circuit 12.

The radio processing circuit 12 carries out radio processing such as D/A conversion, quadrature modulation, up-conversion, band limiting, power amplification or the like on the inputted multicarrier modulated signals and generates radio signals. The generated radio signals are transmitted from the antenna 11.

Next, the reception apparatus 2 will be explained.

Radio signals received from the antenna 21 is inputted to the radio processing circuit 22. The radio processing circuit 22 performs radio processing such as band limiting, down-conversion, quadrature demodulation, A/D conversion on the inputted signals and outputs the signals as received signals. The reception circuits 23(1) to 23(N) demodulate the received signals according to a predetermined demodulation scheme corresponding to the modulation scheme used by the radio communication apparatus and decodes the signals based on a predetermined coding scheme and coding rate. The control data such as a reception state measurement result measured by the radio communication terminal or the like is inputted to the control apparatus 3 and information data such as user data is inputted to a higher layer I/F 24.

Next, the control apparatus 3 will be explained.

The control circuit 31 judges whether or not the radio communication terminal would suffer inter-cell interference using the reception state measurement result data inputted by the reception circuits 23(1) to 23(N). The control circuit 31 stores interference presence/absence information indicating whether or not the radio communication terminal receives interference between neighboring cells in the terminal management information storage 33.

The control station I/F 32 transmits information on the inter-base-station coordinated subcarriers or the like to/from the control station. The control station I/F 32 refers to the radio channel storage 34 and informs the control station of information on the frequency band operating pattern in which the base station operates. The control station I/F 32 stores information related to the inter-base-station coordinated subcarriers informed from the control station in the radio channel storage 34.

The control circuit 31 refers to the radio channel storage 34 and inputs the information related to the inter-base-station coordinated subcarriers as broadcasting information to the coding circuit 20. Furthermore, the control circuit 31 refers to the terminal management information storage 33 and radio channel storage 34 and controls the mapping of the modulated signals of the respective radio communication terminals to the subcarriers by the mapping circuit 14.

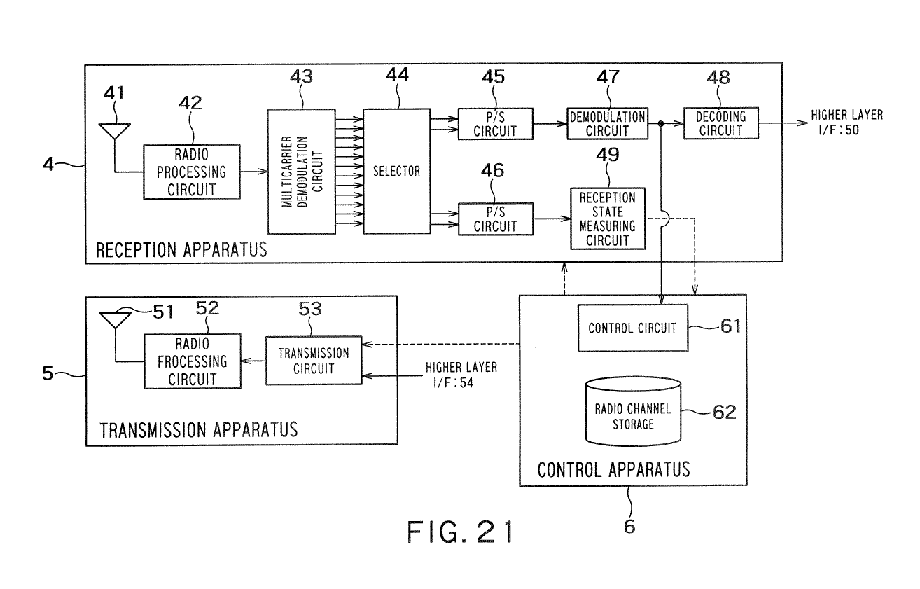

FIG. 21 is a block diagram showing a configuration example of the radio communication terminal.

The radio communication terminal is provided with a reception apparatus 4, a transmission apparatus 5 and a control apparatus 6.

The reception apparatus 4 is provided with an antenna 41, a radio processing circuit 42, a multicarrier demodulation circuit 43, a selector 44, a P/S (parallel/serial) circuit 45, a P/S circuit 46, a demodulation circuit 47, a decoding circuit 48 and a reception state measuring circuit 49.

The transmission apparatus 5 is provided with an antenna 51, a radio processing circuit 52 and a transmission circuit 53.

The control apparatus 6 is provided with a control circuit 61 and a radio channel storage 62. The radio channel storage 62 stores the radio channel information (center frequency, frequency band or the like) used by the radio communication terminal for a communication.

Hereinafter, the reception apparatus 4, transmission apparatus 5 and control apparatus 6 will be explained in detail.

First, the reception apparatus 4 will be explained.

Radio signals received from the antenna 41 is inputted to the radio processing circuit 42, the radio processing circuit 42 carries out radio processing such as band limiting, down-conversion, quadrature demodulation, A/D conversion or the like and inputs the signals as received signals to the multicarrier demodulation circuit 43.

The multicarrier demodulation circuit 43 carries out multicarrier demodulation on the inputted received signals and inputs the multicarrier demodulation result to the selector 44.

The selector 44 inputs data of the subcarriers to be used by the radio communication terminal to the P/S circuit 45, and inputs data of the dedicated subcarriers to be used by the other base station to the P/S circuit 46.

The P/S circuit 45 carries out P/S-conversion for the inputted data of the subcarriers to be used by the radio communication terminal and inputs the data to the demodulation circuit 47. The P/S circuit 46 carries out P/S-conversion for the data of the dedicated subcarriers to be used by the other base station inputted from the selector 44 and inputs the data to the reception state measuring circuit 49.

The demodulation circuit 47 demodulates the data inputted from the P/S circuit 45 according to a demodulation scheme corresponding to a predetermined modulation scheme used at the base station and inputs the demodulation result to the decoding circuit 48. However, when the demodulation result is control data such as information on the subcarriers to be used by the radio communication apparatus, the demodulation result is inputted to the control apparatus 6.

The decoding circuit 48 performs decoding on the inputted demodulation result based on a predetermined coding scheme and coding rate and outputs the decoding result to a higher layer I/F 50.

The reception state measuring circuit 49 measures the reception state of the radio communication apparatus, for example, reception power using the data inputted from the P/S circuit 46 and informs the measurement result to the control apparatus 6.

Next, the transmission apparatus 5 will be explained.

The transmission circuit 53 performs error correcting coding on the control data inputted from the control apparatus 6 and information data such as user data inputted from a higher layer I/F 54 according to a predetermined coding scheme and coding rate, performs modulation according to a predetermined modulation scheme and inputs the modulated signals to the radio processing circuit 52.

The radio processing circuit 52 performs radio processing such as D/A conversion, quadrature modulation, up-conversion, band limiting, power amplification on the inputted modulated signals and generates radio signals. The radio signals generated is transmitted from the antenna 51.

Next, the control apparatus 6 will be explained.

The control circuit 61 inputs the reception state measurement result inputted from the reception state measuring circuit 49 as the control data to the transmission circuit 53. Furthermore, the control circuit 61 stores the information on the subcarriers used by the radio communication terminal informed from the demodulation circuit 47 in the radio channel storage 62. The control circuit 61 informs the selector 44 in the reception apparatus 4 of the information on the subcarriers stored in the radio channel storage 62 and thereby controls the subcarriers received by the radio communication terminal.

What is claimed is:

1. A multicarrier radio communication system including a plurality of base stations whose respective communication areas partially overlap one another and each of which uses same frequency band dividing into one or more divided bands, and a control station which controls the plurality of base stations,
the control station comprising:
a division pattern receiver configured to receive information indicating a division pattern of the frequency band from each the base station;
a dedicated subcarrier setting section configured to set for each the base station some of subcarriers included in at least one divided band in the frequency band, as dedicated subcarriers which are available only for the base station and which are not available for the other base stations; and
a dedicated subcarrier informer configured to inform each the base station of dedicated subcarrier information indicating dedicated subcarriers set for the base stations, and
the base station comprising:
a division pattern informer configured to inform the control station of the information indicating the division pattern;
a dedicated subcarrier information receiver configured to receive the dedicated subcarrier information from the control station;
a dedicated subcarrier information deliverer configured to deliver the dedicated subcarrier information to radio communication terminals inside a communication area;
a judgment section configured to judge whether a radio communication terminal as a communication target is located in an interference area overlapping with a communication area of one or more other base station or in a non-interference area other than the interference area; and
a communication section configured to communicate with the radio communication terminal using the dedicated subcarriers when the radio communication terminal is located in the interference area and using subcarriers other than the dedicated subcarriers and not corresponding to the dedicated subcarriers of the other base stations when the radio communication terminal is located in the non-interference area.

2. The system according to claim 1, wherein subcarriers included in each divided band contains null subcarriers defined to not be available beforehand and available subcarriers other than the null subcarriers, and
the dedicated subcarrier setting section sets available subcarriers corresponding to null subcarriers of an other base station as the dedicated subcarriers of the base station.

3. The system according to claim 1, wherein subcarriers included in each divided band contain null subcarriers defined to not be available beforehand and available subcarriers other than the null subcarriers, and
the dedicated subcarrier setting section sets available subcarriers corresponding to null subcarriers common to all the other base stations as the dedicated subcarriers of the base station.

4. The system according to claim 1, wherein subcarriers included in each divided band contain null subcarriers defined to not be available beforehand and available subcarriers other than the null subcarriers, and
the dedicated subcarrier setting section sets available subcarriers corresponding to available subcarriers of an other base station as the dedicated subcarriers of the base station.

5. The system according to claim 1, wherein subcarriers included in each divided band contain null subcarriers defined to not be available beforehand and available subcarriers other than the null subcarriers, and
the dedicated subcarrier setting section sets available subcarriers corresponding to available subcarriers common to all the other base stations as the dedicated subcarriers of the base station.

6. The system according to claim 1, wherein a division pattern of at least one base station do not use a part of the frequency band as an unused band, and
the dedicated subcarrier setting section sets subcarriers included commonly in an unused band of at least one other base station as the dedicated band of the base station.

7. The system according to claim 1, wherein the dedicated subcarrier setting section sets the dedicated subcarriers for all divided bands in the frequency band.

8. The system according to claim 1, wherein the division pattern informer informs the control station of information indicating the division pattern periodically or when a change is made to the division pattern.

9. The system according to claim 1, further comprising the radio communication terminals,
each of the radio communication terminals including;
a measuring section configured to measure reception power using dedicated subcarriers set for a neighboring base station of a base station to which the radio communication terminal belongs and;
a measurement result informer configured to inform the base station of the information indicating measurement result, wherein
the judgment section in the base station judges that the radio communication terminal is located in the interference area when the measurement result exceeds a threshold and judges that the radio communication terminal is located in the non-interference area when the measurement result is equal to or lower than the threshold.

10. A control station which controls a plurality of base stations whose respective communication areas partially overlap one another and each of which uses same frequency band dividing into one or more divided bands, comprising:
a division pattern receiver configured to receive information indicating a division pattern of the frequency band from each the base station;
a dedicated subcarrier setting section configured to set for each the base station some of subcarriers included in at least one divided band in the frequency band as dedicated subcarriers which are available only for the base station and which are not available for the other base stations; and
a dedicated subcarrier informer configured to inform each the base station of dedicated subcarrier information indicating dedicated subcarriers set for the base stations.

11. The control station according to claim 10, wherein subcarriers included in each divided band contains null subcarriers defined to not be available beforehand and available subcarriers other than the null subcarriers, and
the dedicated subcarrier setting section sets available subcarriers corresponding to null subcarriers of an other base station as the dedicated subcarriers of the base station.

12. The control station according to claim 10, wherein subcarriers included in each divided band contains null subcarriers defined to not be available beforehand and available subcarriers other than the null subcarriers, and
the dedicated subcarrier setting section sets available subcarriers corresponding to null subcarriers common to all the other base stations as the dedicated subcarriers of the base station.

13. The control station according to claim 10, wherein subcarriers included in each divided band contain null subcarriers defined to not be available beforehand and available subcarriers other than the null subcarriers, and
the dedicated subcarrier setting section sets available subcarriers corresponding to available subcarriers of an other base station as the dedicated subcarriers of the base station.

14. The control station according to claim 10, wherein subcarriers included in each divided band contain null subcarriers defined to not be available beforehand and available subcarriers other than the null subcarriers, and
the dedicated subcarrier setting section sets available subcarriers corresponding to available subcarriers common to all the other base stations as the dedicated subcarriers of the base station.

15. The control station according to claim 10, wherein a division pattern of at least one base station do not use a part of the frequency band as an unused band, and
the dedicated subcarrier setting section sets available subcarriers included commonly in an unused part of at least one other base station as the dedicated band of the base station.

16. The control station according to claim 10, wherein the dedicated subcarrier setting section sets the dedicated subcarriers for all divided bands in the frequency band.

17. A base station whose communication area partially overlaps communication areas of other base stations and which uses same frequency band as those of the other base stations dividing into one or more divided band, comprising:
a division pattern informer configured to inform division pattern information indicating division pattern of the frequency band to a control station which controls base stations;
a dedicated subcarrier information receiver configured to receive dedicated subcarrier information indicating dedicated subcarriers set for at least one divided band in the frequency band which are exclusively available and which are not available for the other base stations, together with information indicating dedicated subcarriers of the other base stations from the control station;
an information delivery section configured to deliver the received dedicated subcarrier information to radio communication terminals inside a communication area;
a judgment section configured to judge whether a radio communication terminal as a communication target is located in an interference area overlapping with a communication area of one or more other base station or in a non-interference area other than the interference area; and
a communication section configured to communicate with the radio communication using the dedicated subcarriers when the radio communication terminal is located in the interference area and using subcarriers other than the dedicated subcarriers and not corresponding to the dedicated subcarriers of the other base stations when the radio communication terminal is located in the non-interference area.

18. A multicarrier radio communication method using a plurality of base stations whose their respective communication areas partially overlap one another and each of which uses same frequency band dividing into one or more divided bands, and a control station which controls the plurality of base stations, comprising:
informing division pattern information indicating division pattern of the frequency band from each the base station to the control station;
setting for each the base station some of subcarriers included in at least one divided band in the frequency band as dedicated subcarriers which are available only for the base station and which are not available for other base stations;
delivering dedicated subcarrier information indicating dedicated subcarriers set for the base stations to each the base station and radio communication terminals inside communication areas of the base stations;
judging whether a radio communication terminal as a communication target of the base station is located in an interference area overlapping with a communication area of one or more other base station or in a non-interference area other than the interference area;
carrying out a communication between the base station and the radio communication terminal using dedicated subcarriers set for the base station when the radio communication terminal is located in the interference area; and
carrying out a communication between the base station and the radio communication terminal using subcarriers other than the dedicated subcarriers and not corresponding to the dedicated subcarriers of the other base stations when the radio communication terminal is located in the non-interference area.
